(19) United States
(12) Patent Application Publication
(10) Pub. No.: US 2022/0241129 A1
(43) Pub. Date: Aug. 4, 2022

(54) STRETCHING DEVICE FOR THERAPY

(71) Applicant: Aaron Paul Berg, Taipei City (TW)

(72) Inventor: Aaron Paul Berg, Taipei City (TW)

(21) Appl. No.: 16/709,847

(22) Filed: Dec. 10, 2019

Related U.S. Application Data
(63) Continuation of application No. 13/731,038, filed on Dec. 30, 2012, now Pat. No. 10,500,119.

(51) Int. Cl. A61H 1/02; A63B 23/12; A63B 23/035; A63B 21/062

(52) U.S. Cl. CPC A61H 1/02; A63B 23/1209; A63B 23/03525; A63B 2023/006; A61H 1/0292; A63B 21/0628; A61H 1/0237

(57) ABSTRACT

A stretching device for therapy contains a base including a inclined foot platform axially connected with a rear end thereof and tilting backward, a frame for the inclined foot platform having a horizontal support to abut against or be connected to an upright member extending upwardly from the front end thereof, and the upright member having two handle loops mounted thereon relative to a user's waist, the inclined foot platform is lifted to be used as an oblique platform. Accordingly, the user is capable of stretching calves, hamstrings, lower back, upper back, shoulders and neck, also to provide traction to the spine.

### RELATED APPLICATIONS

The current application is a continuation of U.S. patent application Ser. No. 13/731,038 entitled Stretching Device for Therapy, filed Dec. 30, 2012, now U.S. Pat. No. 10,500,119, the entire contents of which are expressly incorporated herein by reference.

### FIELD OF THE INVENTION

The present invention relates to a stretching device, and more particularly to a stretching device for training and therapy.

### BACKGROUND OF THE INVENTION

A conventional stretching device is disclosed in U.S. Pat. Nos. 5,456,649, 4,419,990, 864,188, yet it cannot cure muscle tension. Another conventional stretching device is disclosed in U.S. Pat. Nos. 7,841,973, 6,705,974, 4,819,936 so as to stretch muscle groups, such as hamstrings, calves and Achilles tendons, but it cannot stretch muscles of an upper body.

In addition, U.S. Pat. No. 6,569,069 discloses a ‘Back Stretcher’ device which is used to stretch the spine but it is only applied to stretch abdominal muscles, so the back muscles cannot be stretched effectively.

Also, a traction exercise apparatus is disclosed in U.S. patent filing Ser. No. 12/729,016 and US Publication No. 2011/0230808, yet the user's legs have to be tied and the body is hanged upside down, having an unsafe and impractical operation. Furthermore, the user must use much force to grip the handle bars thus not allowing his shoulders to relax, the position of the users head tilting backward is contrary to the position needed to fully stretch the back and neck, the position of the user's feet are not flexed to stretch the calves and hamstrings, thus the therapeutic stretching is insufficient and incomplete.

The present invention has arisen to mitigate and/or obviate the afore-described disadvantages.

### SUMMARY OF THE INVENTION

The primary object of the present invention is to provide a stretching device for therapy which in operation, the base is placed on the ground, and the inclined foot platform is sloped 30 to 40 degrees relative to the ground, then the frame abuts against the upright member, and frame is adjusted to match various users' body sizes and flexibility levels, thereafter a user stands on the inclined foot platform, stoops down and places his/her hands through and grips the two handle loops while keeping legs straight and leaning backward to stretch his/her body, hence the user is capable of stretching calves, hamstring, lower back, upper back, shoulder and neck, also to provide traction to the spine.

To obtain the above objectives, a stretching device for therapy provided by the present invention contains:

a base including a inclined foot platform axially connected therewith and tilting backward, the inclined foot platform having an upright member extending upwardly and connecting with a front end thereof, and the upright member having two handle loops mounted thereon relative to a user's waist;

wherein the base further includes a first frame, a second frame, and a third frame, the first frame has an outer rack, two adjustable supports, and the inclined foot platform, the inclined foot platform is axially connected with the first frame, and the two adjustable supports are positioned between the inclined foot platform and the outer rack, and the second frame is axially connected with the front end of the first frame, the third frame is coupled with the second frame.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a stretching device for therapy according to a first embodiment of the present invention.

FIG. 2 is a perspective view showing the exploded components of the stretching device for therapy according to the first embodiment of the present invention.

FIG. 3 is another perspective view showing the assembly of the stretching device for therapy according to the first embodiment of the present invention.

FIG. 4 is a plan view showing the operation of the stretching device for therapy according to the first embodiment of the present invention.

FIG. 5 is a plan view showing the foldable operation of the angle inclining structure for convenient stowage according to the preferred embodiment of the present invention.

FIG. 6 is a perspective view showing the assembly of a stretching device for therapy according to a second embodiment of the present invention.

FIG. 7 is a perspective view showing the assembly of a stretching device for therapy according to a third embodiment of the present invention.

FIG. 8 is a perspective view showing the assembly of a non-adjustable inclined foot platform of a stretching device for therapy according to a fourth embodiment of the present invention.

FIG. 9 is a perspective view showing the assembly of a stretching device for therapy according to a fifth embodiment of the present invention.

FIG. 10 is a perspective view showing a part of the exploded components of a stretching device for therapy according to a fifth embodiment of the present invention.

FIG. 11 is a perspective view showing the operation of the stretching device for therapy according to the fifth embodiment of the present invention.

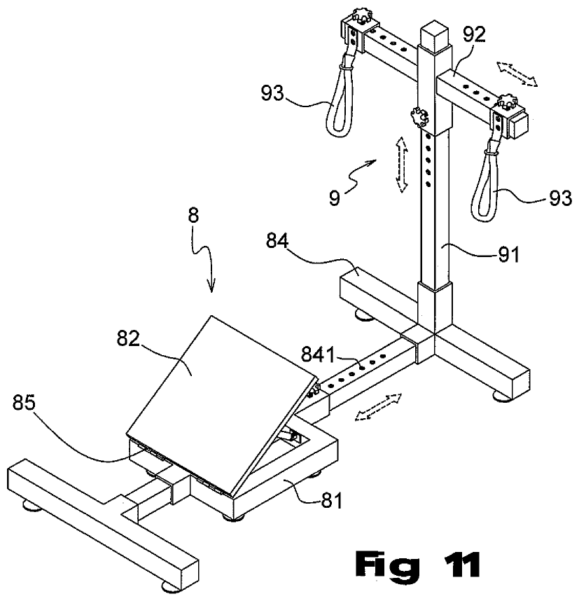

FIG. 12 is a plan view showing the operation of a stretching device for therapy according to the fifth embodiment of the present invention.

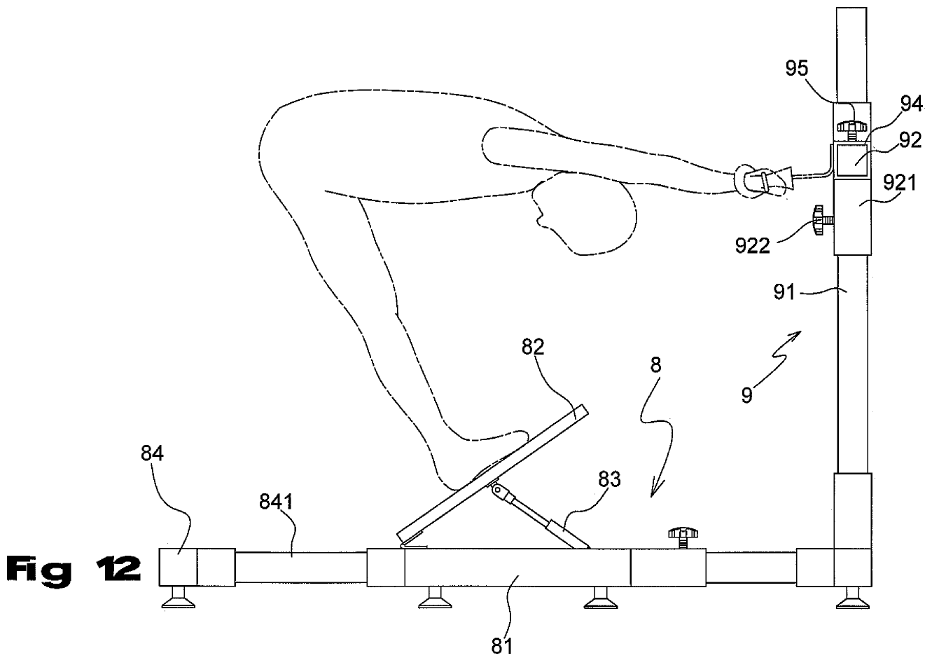

### DETAILED DESCRIPTION OF THE PREFERRED EMBODIMENTS

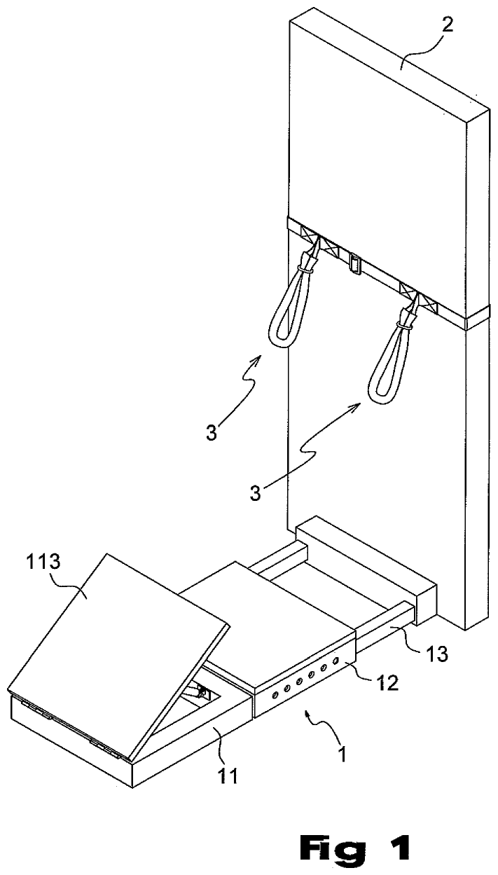

With reference to FIG. 1, a stretching device for therapy according to a first embodiment of the present invention comprises a base 1, placed on the ground, connecting to or abutting against an upright member 2 (such as a closed door in a doorway), and including a first frame 11 disposed on a rear end thereof; and two handle loops 3 mounted on the upright member 2. A user may choose a closed door which is appropriate to perform stretching using the invention.

Referring to FIG. 1, the base 1 further includes the first frame 11, a second frame 12, and a third frame 13, wherein the first frame 11 has an outer rack 111, two adjustable supports 112, and an inclined foot platform 113, the inclined foot platform 113 is axially connected with the rear end of the first frame 11 by way of a plurality of first hinges 114, such that the inclined foot platform 113 is folded on or tilted relative to the outer rack 111.

It is preferable that the two adjustable supports 112 are positioned at a plurality of positions so that a slope of the inclined foot platform 113 is adjustable.

The second frame 12 is axially connected with the front end of the first frame 11 by ways of a plurality of second hinges 116, so it is extended and located at a flat plane with the first frame 11 or is folded to overlapped with the first frame 11.

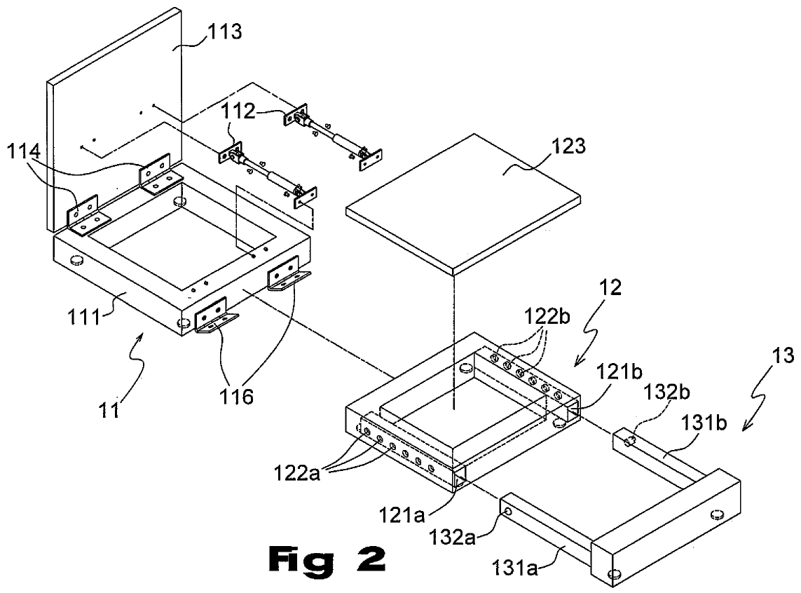

The third frame 13 is coupled with the second frame 12. The second frame 12 has two parallel grooves 121a, 121b defined therein, and the third frame 13 is formed in a U shape and has two legs 131a, 131b inserted into the two grooves 121a, 121b. A fixing mechanism is defined between the second frame 12 and the third frame 13. As shown in FIG. 2, the fixing mechanism includes a plurality of holes 122a, 122b formed in the two grooves 121a, 121b and two movable balls 132a, 132b fixed on the legs 131a, 131b. When the third frame 13 slides inwardly or outwardly, one of the plurality of holes 122a, 122b retains with one of the two movable balls 132a, 132b so that the third frame 13 is fixed. In other words, a length of the second frame 12 and the third frame 13 is defined between the plurality of holes 122a, 122b and the two movable balls 132a, 132b, thus adjusting the second frame 12 and the third frame 13.

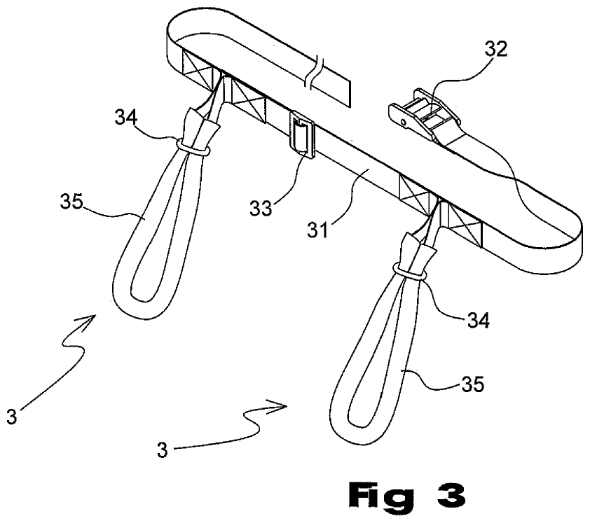

Referring further to FIG. 3, the two handle loops 3 are fixed on an adjusting belt 31, and the adjusting belt 31 has a cam buckle 32 mounted on one end thereof and an adjustment fastener 33 so that the adjusting belt 31 is tied on the upright member 2 (as illustrated in FIG. 1). Accordingly, a user places one of his/her hands through each handle loop 3 and grips his/her fingers around the handle loop 3 on the other side to prevent his/her hands from slipping out. Each handle loop 3 has a rigid ring 34 fitted thereon so as to lessen the mouth of each handle loop 3, such that the user pulls the rigid ring around the handle loops closer to his/her hands to make the handle loop size smaller and easier to grip. Each handle loop 3 also has a foam sleeve 35 covered thereon so as to hold the user's hands in each handle loop 3 comfortably and securely. Preferably, the belt with handle loops is to be used with the frame and foot pedestal, and it can be also used independently. For example, when traveling, it may not be convenient to carry the inclined foot pedestal; however, the belt may be easily carried and used on any door or upright member for the user to stretch his back and shoulders in a similar way.

The belt with handle loops can be also used independently without the frame and foot pedestal.

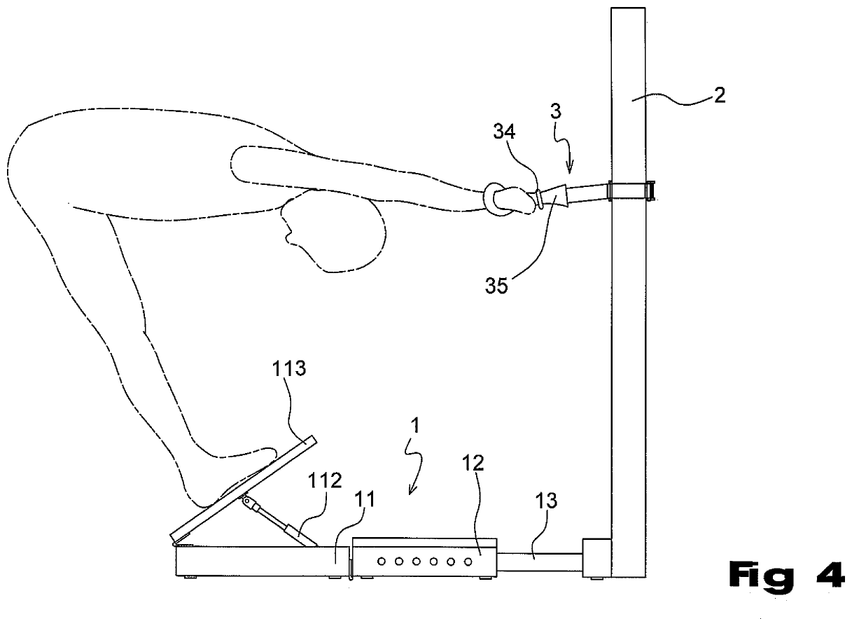

With reference to FIG. 4, in operation, the base 1 is placed on the ground, and the inclined foot platform 113 is sloped 30 to 40 degrees relative to the ground, then the third frame 13 abuts against the upright member 2, and the third frame 13 is adjusted to match various users' body sizes and flexibility levels, thereafter a user stands on the inclined foot platform 113, stoops down and places his/her hands through and grips the two handle loops 22 while keeping legs straight and leaning backward to stretch his/her body, hence the user is capable of stretching calves, hamstring, lower back, upper back, shoulder and neck, also to stretch the spine. It is to be noted that the two handle loops 3 are fixed at a height of the upright member 2 approximately relative to the user's waist, and a width between the two handle loops 3 is equal to a width of the user's shoulder.

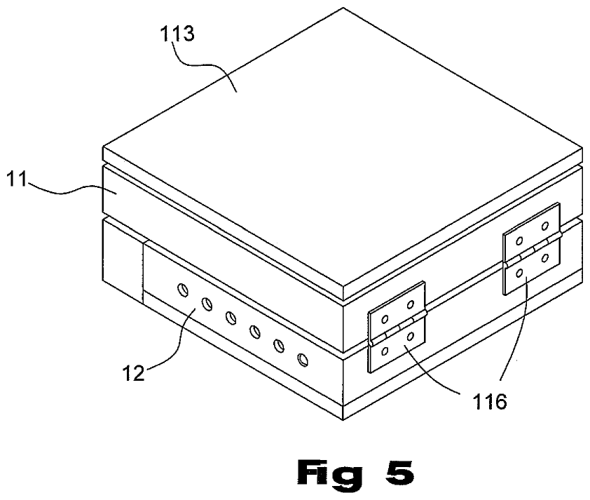

As shown in FIG. 5, when the stretching device is not used, the base 1 is folded to be more compact. In detail, the first frame 11 or the second frame 12 is turned to superpose each other. This makes the stretching device easy to be stored.

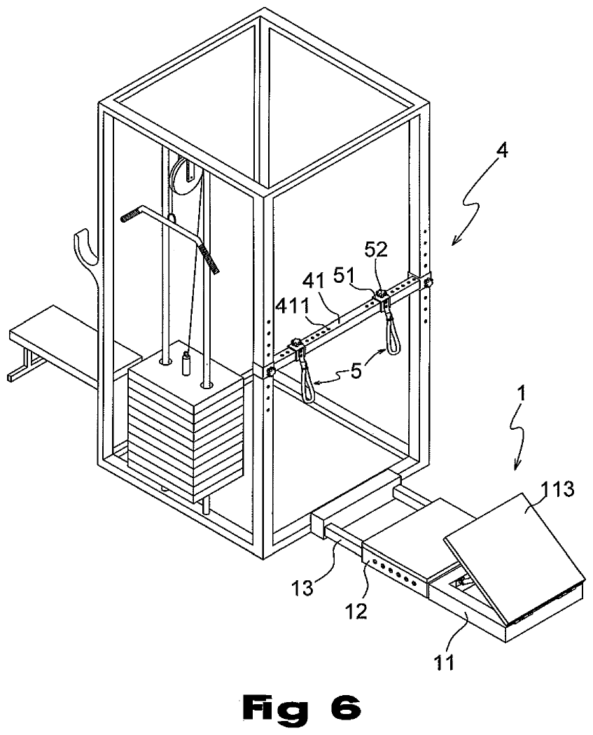

As illustrated in FIG. 6, a stretching device for therapy according to a second embodiment of the present invention comprises a base 1, the base 1 matches with an upright member of a fitness device 4, and the fitness device 4 includes a horizontal rod 41 mounted on one side thereof and facing to the base 1, the horizontal rod 41 has two handle loops 5 disposed on two fitting seats 51, and each fitting seat 51 is fitted on the horizontal rod 41 and has a fixing element 52 for fixing the each fitting seat 51 on the horizontal rod 41. The horizontal rod 41 has plural orifices 411 for inserting two fixing elements 52 therein so as to adjust a width between the two handle loops 5.

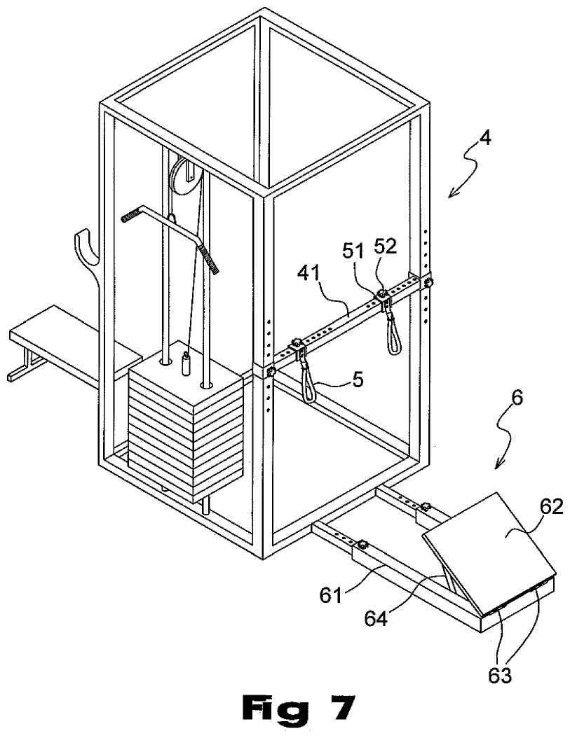

Referring to FIG. 7, a stretching device for therapy according to a third embodiment of the present invention matches with an upright member of a fitness device 4, and the fitness device 4 is integrally connected with a base 6, and the base 6 includes an adjustable mount 61 and a inclined foot platform 62. The inclined foot platform 62 is connected with a rear end of the adjustable mount 61 by ways of plural hinges 63, and between the inclined foot platform 62 and the adjustable mount 61 are defined two posts 64. Thereby, the inclined foot platform 62 is overlapped or obliquely fixed on the adjustable mount 61 so that the inclined foot platform 62 is lifted to be used as an oblique platform.

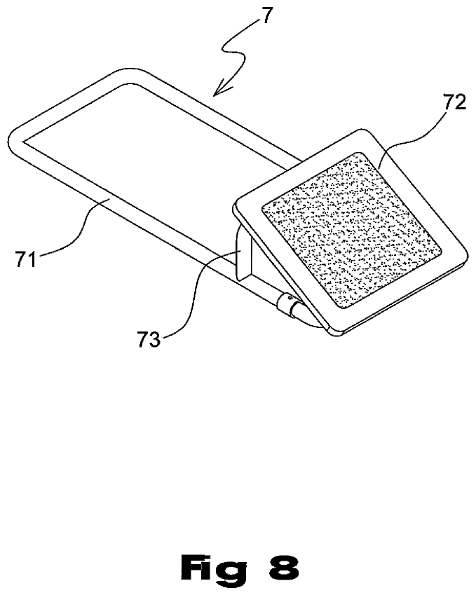

Referring to FIG. 8, a stretching device for therapy according to a fourth embodiment of the present invention comprises a base 7, and the base 7 includes a frame 71 and an inclined foot platform 72. The inclined foot platform 72 has a rear end coupled with a rear end of the frame 71, and the frame 71 and the inclined foot platform 72 are supported by a supporting rack 73 so as to form a beveled angle between the frame 71 and the inclined foot platform 72, the frame 71 extends outward from a front end of the inclined foot platform 72 so as to abut against an upright member 2.

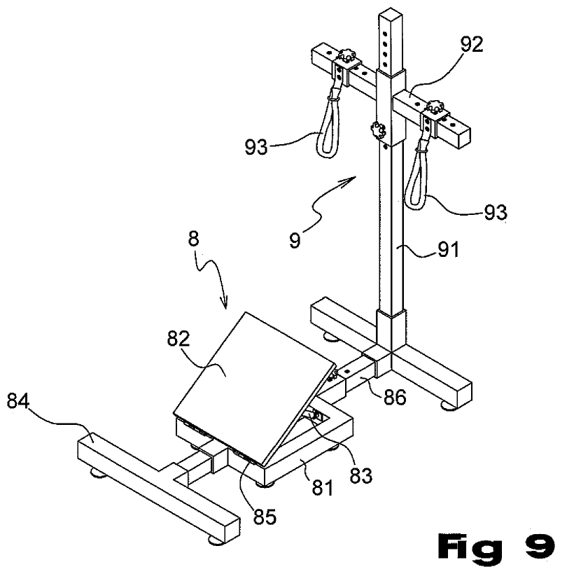

With reference to FIG. 9, a stretching device for therapy according to a fifth embodiment of the present invention comprises a base 8, the base 8 includes a frame 81, a inclined foot platform 82, two adjustable supports 83, and a fixed pedestal 84. The inclined foot platform 82 is connected with a rear end of the frame 81 by means of plural hinges 85, and the frame 81 is mounted on the fixed pedestal 84, the two adjustable supports 83 are fixed between the inclined foot platform 82 and the frame 81, and the two adjustable supports 83 are positioned at a plurality of positions so that the inclined foot platform 82 is lifted to be used as an oblique platform. The fixed pedestal 84 has a front end coupling with an upright member 9, and the upright member 9 has a column 91 on which a movable stem 92 is disposed, and the movable stem 92 has two handle loops 93.

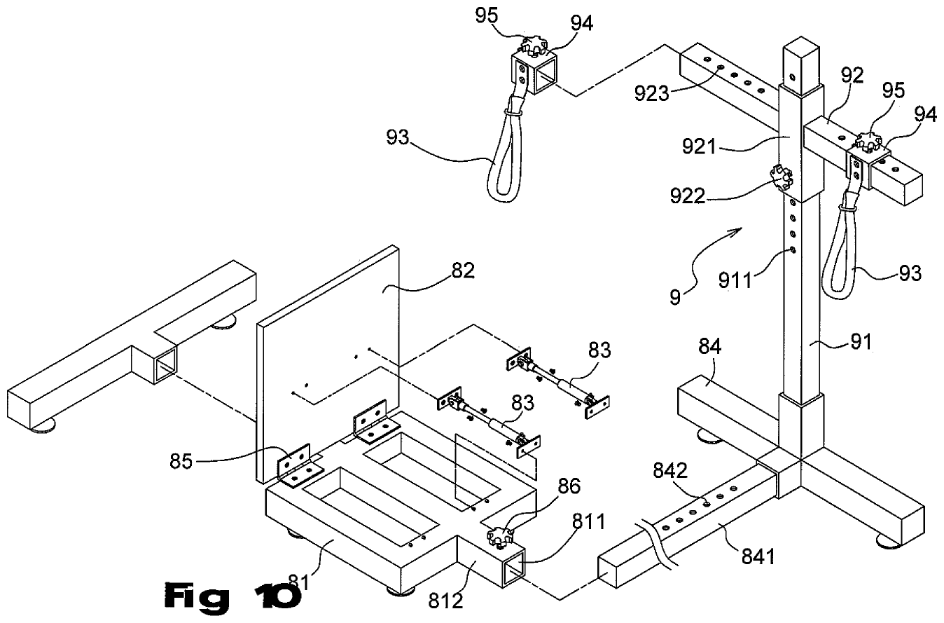

As shown in FIG. 10, the frame 81 has a slot 811 defined therein so as to fit an extension 841 of the fixed pedestal 84, such that the fixed pedestal 84 is moved and fixed on the frame 81, wherein the slot 811 is defined in a tube 812 of the frame 81, and two ends of the tube 812 extend out of the frame 81, wherein the tube 812 has a first fix knob 86 mounted thereon, and the extension 841 has a plurality of apertures 842 defined thereon relative to the first fix knob 86.

The movable stem 92 of the upright member 9 has a sheath 921 arranged on a central position thereof so as to fit the column 91, and the sheath 921 has a second fix knob 922 disposed thereon so that the movable stem 92 is positioned on the column 91. The column 91 has a plurality of openings 911 defined thereon so as to insert the second fix knob 922.

The two handle loops 93 are mounted on a locking holder 94, and the locking holder 94 is fitted on the movable stem 92 and has a third fix knob 95 for fixing the locking holder 94 on the movable stem 92, the movable stem 92 has a plurality of pores 923 formed thereof so as to insert the fix knob 95.

Thereby, the base 1 is moved and fixed on the extension 841 of the fixed pedestal 84, the plurality of openings 911 of the column 91 are served to adjust the movable stem 92 at a suitable height of the column 91, and the two handle loops 93 are moved on the horizontal rod 41 by means of the locking holder 94 and are fixed in two of the plurality of pores 923 so as to adjust a distance between the two handle loops 93.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A stretching device for therapy comprising: a base including an inclined foot platform connected therewith and tilting backward, the base extending forward and being connected to or abut against an upright member extending upwardly from the front end thereof, and the upright member having two handle loops or a handlebar mounted thereon so as to be held by a user.

2. The stretching device for therapy as claimed in claim 1, wherein the base further includes a first frame, a second frame, and a third frame, the first frame has an outer rack, two adjustable supports, and the inclined foot platform, the inclined foot platform is axially connected with the first frame, and the two adjustable supports are positioned between the inclined foot platform and the outer rack, and the second frame is axially connected with the front end of the first frame, the third frame is coupled with the second frame.

3. The stretching device for therapy as claimed in claim 2, wherein the two adjustable supports are positioned at a plurality of positions so that an inclination of the inclined foot platform is adjustable.

4. The stretching device for therapy as claimed in claim 2, wherein the inclined foot platform is axially connected with a rear end of the first frame by ways a plurality of first hinges, the second frame is extended and located at a flat plane with the first frame or is folded to overlapped with the first frame.

5. The stretching device for therapy as claimed in claim 4, wherein the third frame has two legs inserted into the two grooves of the second frame and can be fixed by a fixing mechanism at a plurality of positions.

6. The stretching device for therapy as claimed in claim 1, wherein the handle loops are fixed to a belt which can be fastened to an upright member.

7. The stretching device for therapy as claimed in claim 6 wherein the belt has a cam buckle mounted on one end thereof to be used as the adjustment fastener so that the belt is tied around the upright member, and the belt is fixed with an adjustment buckle which can adjust the distance between the two handle loops.

8. The stretching device for therapy as claimed in claim 1, wherein each handle loop has a rigid ring fitted thereon so as to lessen the mouth of each handle loop, and each handle loop also has a foam sleeve covered thereon for added comfort and stability.

9. The stretching device for therapy as claimed in claim 1, wherein the upright member is a fitness device to which is mounted thereon and facing toward the base and two handle loops or a handlebar for gripping.

10. The stretching device for therapy as claimed in claim 9, wherein the fitness device has a horizontal rod mounted on one side thereof and facing to the base, the horizontal rod has two handle loops disposed on two fitting seats, and each fitting seat is fitted on the horizontal rod and has a fixing element for fixing the each fitting seat on the horizontal rod, the horizontal rod has plural orifices for inserting two fixing elements therein so as to adjust a width between the two handle loops, and the fitness device is integrally connected with a base, and the base includes an adjustable mount and the inclined foot platform, and between the inclined foot platform and the adjustable mount are defined two posts or adjustable supports.

11. The stretching device for therapy as claimed in claim 1, wherein the base includes a frame and a inclined foot platform, the inclined foot platform has a rear end coupled with a rear end of the frame, and the frame and the inclined foot platform are supported by a supporting rack so as to form a beveled angle between the frame and the inclined foot platform, the frame extends outward from a front end of the inclined foot platform so as to connect with or to abut against an upright member.

12. The stretching device for therapy as claimed in claim 1, wherein the base includes a frame, an inclined foot platform, and a fixed pedestal, the inclined foot platform is connected with a rear end of the frame, and the frame is mounted on the fixed pedestal.

13. The stretching device for therapy as claimed in claim 12, wherein two adjustable supports are fixed between the inclined foot platform and the frame, and the two adjustable supports are positioned at a plurality of positions so that the inclined foot platform is lifted to be used as an oblique platform, and the frame has a slot defined therein so as to fit an extension of the fixed pedestal, such that the frame is moved and fixed on the pedestal.

14. The stretching device for therapy as claimed in claim 12, wherein the fixed pedestal has a front end coupling with an upright member, and the upright member has a column on which a movable stem is disposed, and the movable stem has two handle loops or a handlebar mounted thereon.

15. The stretching device for therapy as claimed in claim 14 wherein the height of the movable stem can be adjusted and fixed by a fixing mechanism.

16. The stretching device for therapy as claimed in claim 14, wherein the two flexible handle loops are mounted on a locking holder, and the locking holder is fitted on the movable stem and has a third fix knob for fixing the locking holder on the movable stem, wherein the movable stem has a plurality of pores formed thereof so as to insert the fix knob.

17. The stretching device for therapy as claimed in claim 1, wherein the inclined foot platform is sloped 20 to 45 degrees relative to the ground.

18. The stretching device for therapy as claimed in claim 1, wherein a width between the two handle loops is adjustable to be equal to a width between the user's shoulders.

19. The stretching device for therapy as claimed in claim 1 wherein the height of the handle loops or handlebar is adjustable relative to the ground.

20. The stretching device for therapy as claimed in claim 1 wherein the distance of the inclined foot platform from the upright member is adjustable.

21. The stretching device for therapy as claimed in claim 6 wherein the belt with handle loops can be also used independently without the frame and foot pedestal.
